(19) United States
(12) Patent Application Publication
(10) Pub. No.: US 2022/0243986 A1
(43) Pub. Date: Aug. 4, 2022

(54) CCF HEATER CORE ASSEMBLY

(71) Applicant: PRANAV VIKAS INDIA PVT LIMITED, Haryana (IN)

(72) Inventors: Yuji YAMAMOTO, Haryana (IN); Sanjay CHAWLA, Haryana (IN); Hemanshu .,, Haryana (IN); Kavit BANSAL, Haryana (IN); Rohan Himanshu SHAH, Haryana (IN); Nipun VASHISHTH, Haryana (IN); Abhay KUMAR, Haryana (IN); Vijayaraghavan S., Haryana (IN); Dakshinamurthy GOVINDARAJ, Haryana (IN); K. SRINIVAS, Haryana (IN)

(21) Appl. No.: 17/615,700

(22) PCT Filed: Jul. 18, 2019
(86) PCT No.: PCT/IN2019/050531

§ 371 Date: Dec. 1, 2021

(30) Foreign Application Priority Data
Jun. 4, 2019 (IN) 2019 11022111

(51) Int. Cl. F28D 1/053; F28F 1/02; F28F 1/12

(52) U.S. Cl. CPC F28D 1/05391; F28F 1/025; F28D 2021/0096; F28F 1/022; F28F 1/126

(57) ABSTRACT

A heater core assembly (10) comprising: a core (12) comprising a plurality of micro-tubes (13A, 13B), the plurality of micro-tubes (13A, 13B) being stacked in horizontal rows (15) between at least two headers (18) by inserting ends of each of the micro-tubes (13A,13B) into slots (42A, 42B) provided in the headers (18); a partition plate (30) disposed vertically in each of header (18) to define two vertical chambers (18A, 18B); wherein each of the horizontal rows (15) include at least one first micro-tube (13A) inserted in the first chamber (18A) and at least second micro-tube (13B) inserted in the second chamber (18B) to enable flow of the coolant in the core assembly (10).

### TECHNICAL FIELD

The present subject matter, in general, relates to a heater core assembly for HVAC system of automobiles and in particular, relates to a two row single extruded micro channel based heater core assembly for electric vehicles thermal management or HVAC system.

### BACKGROUND

Generally speaking the main function of heater core assembly is the use of battery hot coolant as a heat source, typically to provide surplus heat from electric vehicle batteries to passenger cabin. The battery transfers heat to the coolant which then passes through a heat-exchanger in HVAC circuit and takes extra heat of refrigerant between compressor and condenser. This hot coolant passes this heat to passenger cabin by a heater core assembly. The cooled coolant flows back into the battery to maintain its temperature continuously. In electric vehicle thermal management or HVAC system there is a lower heat transfer coefficient at coolant side due to smaller coolant mass flow rate and smaller temperature difference between air and coolant. Currently, electric heaters/PTC heaters are used for cabin heating because conventional I and U type heater cores becomes oversized for creating such high temperature differences and high thermal performance with small ITD (Water inlet Temperature-Air inlet temperature). However, use of electric vehicle thermal management system or HVAC circuit, an electric heater/PTC Heater consumes battery power rapidly and leads to decrease in electric vehicle mileage/charge in winter conditions. Moreover, the general trend was to use oval tubes in conventional heater cores I or U flow, due to which a two piece header tank assembly is required as indicated in FIG. 5b and hence increased number of brazed/welded joints and occurrence of leakage.

Since a compact, lightweight, durable, high thermal performance and robust heater core assembly for an electric vehicle HVAC system is vital, there is a growing demand for efficient and light weight heater core with variable core sizes, which can create a higher temperature difference around 25° C. to 40° C. of battery coolant between its inlet and outlet with the given constraints and which overcomes the aforementioned and other challenges. This type of heater can be called as cross counter flow heater core and it will be referred as CCF heater core in this disclosure.

### SUMMARY

It is an object of the present subject matter to provide heater core assembly used in thermal management system or HVAC of electric vehicles.

It is an object of the present subject matter to provide a heater core assembly capable to replace conventional heater cores PTC heaters used in HVAC system of electric vehicle thermal management system.

It is another object of the present subject matter to provide a heater core assembly configured to use battery coolant heat and refrigerant heat between compressor and condenser to heat the passenger cabin.

It is another object of the present subject matter to provide a heater core assembly having a decreased number of elements which results in lesser number of welding/brazing joints, hence decreasing occurrence of leakage.

It is another object of the present subject matter to provide a heater core assembly having high strength and capacity to withstand high burst pressure.

It is yet another object of the present subject matter to provide a heater core assembly which allows flexible core options with superior performance in comparison to conventional heater cores.

It is yet another object of the present subject matter to provide a heater core assembly capable of a superior thermal performance.

It is yet another object of the present subject matter to provide a heater core assembly capable of cooling battery coolant and reducing battery power consumption, hence improving electric vehicle mileage/charge in winter conditions.

It is yet another object of the present subject matter to provide a heater core assembly having an economic design, flexible manufacturing and low cost.

### BRIEF DESCRIPTION OF DRAWINGS

These and other features, aspects, and advantages of the present invention will become better understood when the following detailed description is read with reference to the accompanying drawings in which like characters represent like components throughout the drawings, wherein:

FIG. 1 illustrates isometric view of CCF heater core assembly

FIG. 2 illustrates exploded view of CCF heater core assembly showing all its components individually

FIG. 3a illustrates front view of the CCF heater core assembly showing coolant flow direction

FIG. 3b illustrates back view of the CCF heater core assembly showing coolant flow direction

FIG. 4a illustrates an isometric view of double row single piece extruded micro channel

FIG. 4b illustrates a front view of double row single piece extruded micro channel

FIG. 5a illustrates CCF heater core with header and oval tubes

FIG. 5b illustrates conventional heater core with 2 piece header and oval tubes showing brazing joint of 2 piece header

FIG. 6 illustrates a flow diagram of coolant as multi pass, multi flow in heater core assembly

FIG. 7a illustrates Left side partition plate showing holes for coolant transfer from front to back side of the heater core

FIG. 7b illustrates Right side partition plate of the heater core assembly

FIG. 8 illustrates Left side header of the heater core assembly

FIG. 9 illustrates two heater core designs for different thermal performance requirements

### DETAILED DESCRIPTION

The embodiments of the present subject matter are described in detail with reference to the accompanying drawings. However, the present subject matter is not limited to these embodiments which are only provided to explain more clearly the present subject matter to the ordinarily skilled in the art of the present disclosure. In the accompanying drawings, like reference numerals are used to indicate like components.

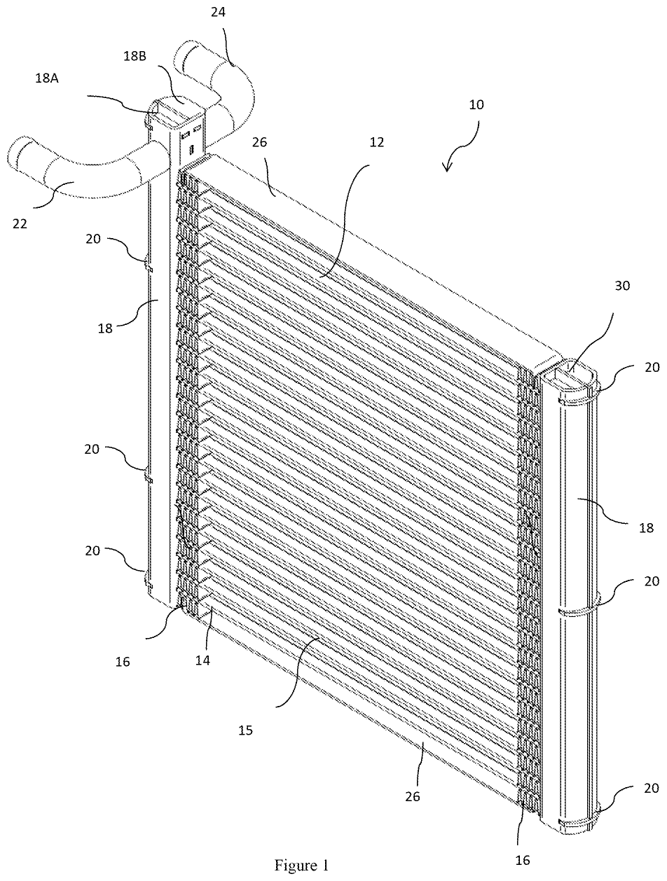

FIG. 1 illustrates a perspective view of a CCF heater core assembly (10) for electric vehicle in accordance with an embodiment of the present subject matter, wherein the heater core assembly (10) is cross counter flow (CCF) heater core assembly. Said CCF heater core assembly (10) comprises a core (12) consisting of a plurality of fins (16), a plurality of micro tubes (13A, 13B) which are being stacked in a number of Vertical rows (15) wherein the plurality of fins (16) is disposed between each row (15)) An end of each of the micro-tube (13A, 13B) is inserted into a plurality of slot (42A, 42B) provided in a D-header (18) to hold the core (12) in a position. An end plate/baffle (20) is disposed at the proximity of upper and lower edge of the each D-header (18) to close up the D-header (18) and support the D-header (18) for structural rigidity. Moreover, at least one baffle (20) is inserted in a slot formed on a partition plate (30) at various locations of the each D-header (18) to increase the number of passes of coolant in the each of the D-header or to increase the strength of the D-header (18). The partition plate (30) provides internal strength to the D-header (18) and prevents bursting and internal leakage of the coolant inside the D-header (18). Also, the partition plate (30) is disposed vertically in each of the D-headers and divides D-header (18) into two different chambers (18A, 18B) wherein at least one micro-tube (13A) is inserted in the first chamber (18A) and at least one micro-tube (13B) is inserted in the second chamber (18B) which enables in counter flow effect of coolant. The coolant flows into the first micro-channel (14) and air flows through fins (16) to enable cross flow between hot coolant and air thereby aforementioned invention is termed as cross counter flow (CCF) heater core.

FIG. 1 also indicates that a coolant inlet (22) and a coolant outlet (24) is disposed on each side of at least one D-header (18) for in-flow and out-flow of the coolant to and from the CCF heater core assembly (10) respectively. At least one plate (26) is disposed at the top and at the bottom of horizontally stacked rows (15) of the micro-tubes (13A, 13B) to support the plurality of last fins (16) and to provide stiffness to the core (12).

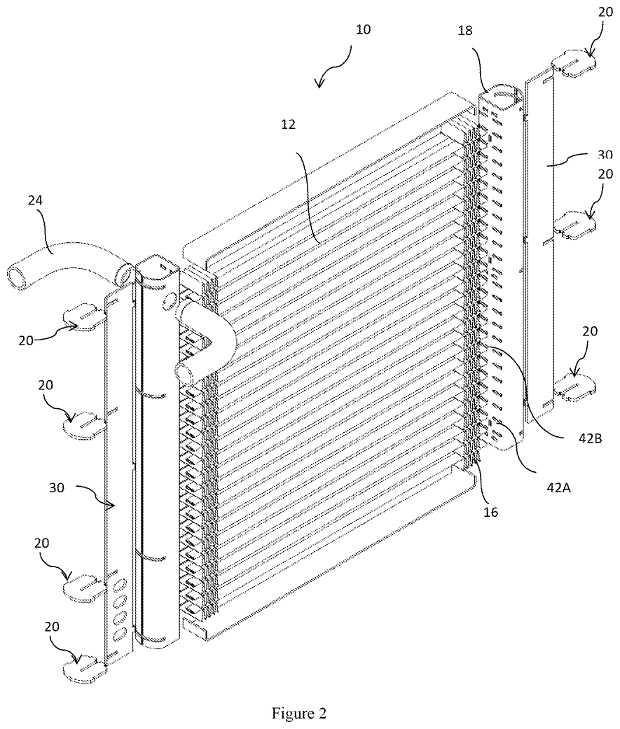

A position of the coolant inlet (22) and the coolant outlet (24) is indicated in FIG. 2 wherein the coolant inlet (22) is connected to the first chamber (18A) and the coolant outlet (24) is connected to the second chamber (18B) of the same or another D-header (18) depending on the number of passes. FIG. 2 also clearly indicates that the partition plate (30) is disposed in the D-header (18) to create two chambers (18A, 18B) in the D-header (18) for passing coolant in the D-header (18) and to provide internal strength to the D-header (18).

In different embodiment of the present invention the D-header (18) is a seam welded D-header with swage down plurality of micro-channels (14) provide more contact area for brazing, in turn controlling the insertion depth and giving rise to a leak proof heater core assembly (10). The same seam welded D-header (18) can be ribbed for sever burst pressure requirements if the application demands. The invention can be in fact used with both seam welded D-header and two-piece D-header, a seam welded D-header is preferred embodiment in present invention. D-header (18) and header chambers (18a, 18B) may vary depending upon the number of coolant passes in the heater core (12).

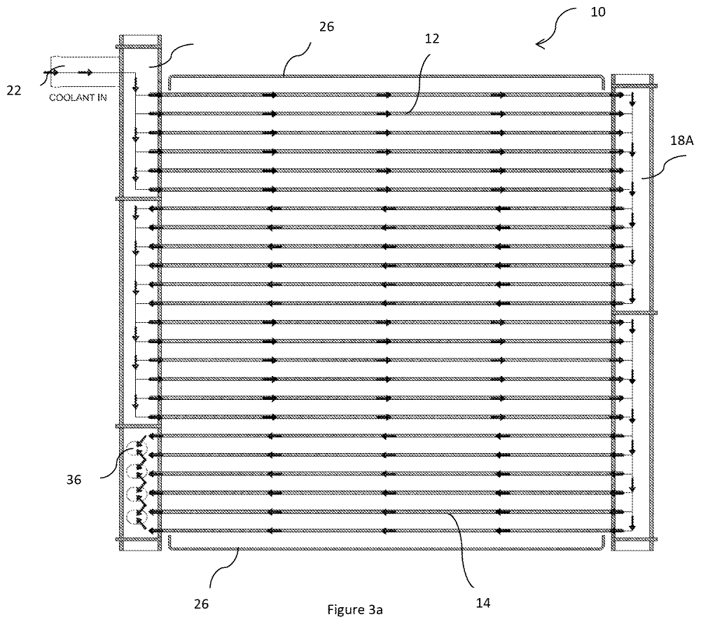

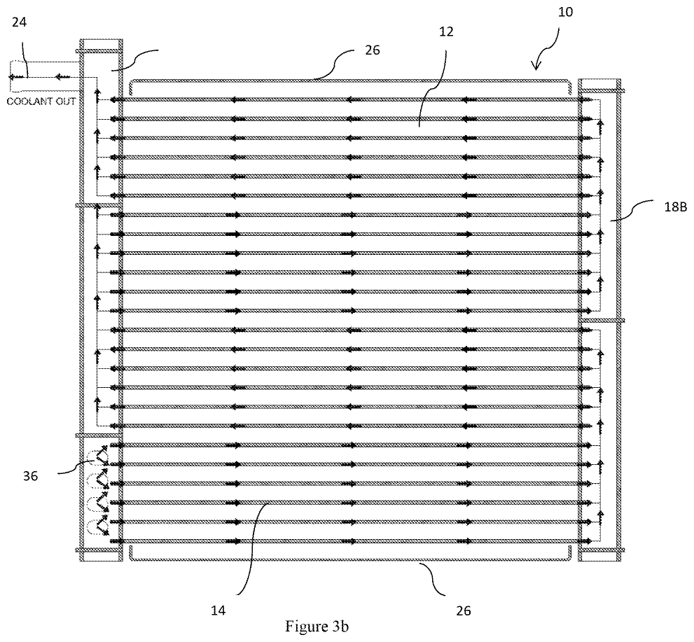

Electric vehicles heater core is required to be lightweight and compact for a better performance of the vehicle. This present subject matter provides an apt solution to reduce the heater core assembly's weight by almost 20 to 30% due to use a core (12) comprising the plurality of micro-channels (14), multi pass and multi flow architecture in place of I and U type conventional Heater Core (34) as indicated in FIGS. 3a and 3b.

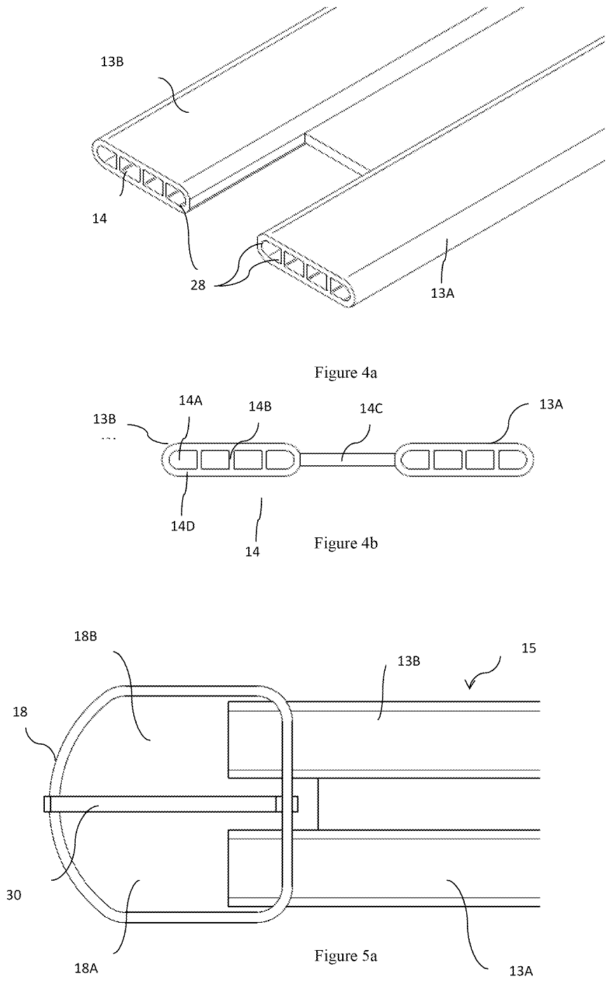

FIGS. 4a and 4b illustrate at least one micro-tube (13A, 13B) comprising a plurality of micro-channels (14), including a plurality of small fillets (28) at the corners. First time a double row single piece micro tube is used for heater core application. Double row single piece micro tube is used for better coolant/air flow, for higher surface area to heat transfer, for higher strength of the core and also manufacturing tolerances can be easily met. The profile of the extruded micro-channel (14) provokes reduced coolant side restriction. Microchannel holes (14A), ribs (14B), wall thickness (14D) and extruded connector (14C) length and thickness between two microchannel rows can vary depending on the customer requirements.

Use of seam welded D-header (18) in place of two piece D-headers which eliminate the numerous brazing joints (34) as shown in FIGS. 5a and 5b. The heater core assembly (10) in accordance with an embodiment of the present subject matter is adapted to provide in multiple size options of the core (12). The length of the tube as well as the height of the core (12) can be altered as per requirement with minimum tooling. Moreover, different types of fins (16) can be used for selected micro-channels (14). It means geometrical parameters of fin can vary with same or different micro channels. The CCF heater assembly (10) is configured to allow depth variation along the air flow direction, fins (16) and micro-channel (14) depth can be varied as per space constrains. Use of extruded micro-channels (14) with D-header (18) facilitates a leak proof design.

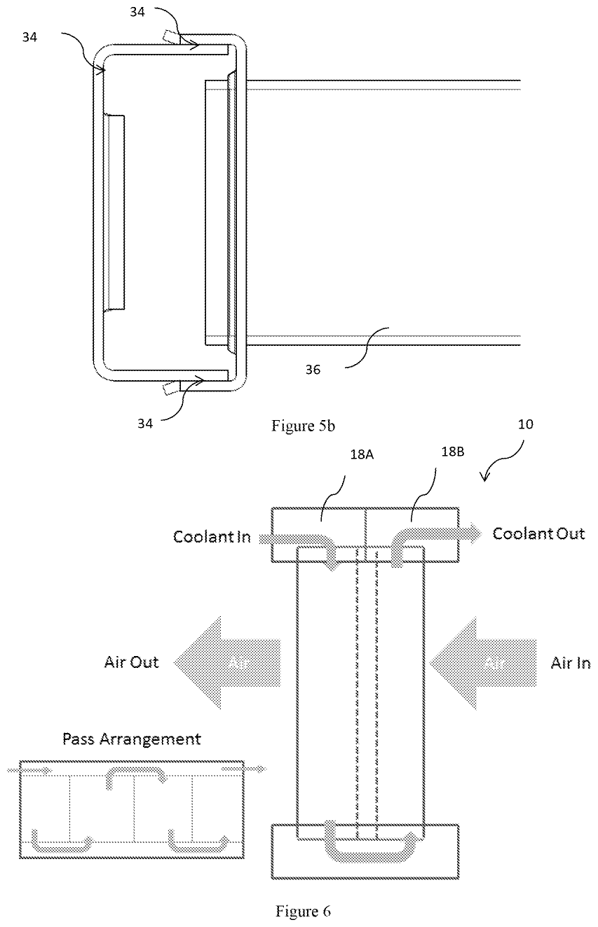

FIG. 6 shows the novel part of the heater core design showing multi flow and multi pass structure. There is cross flow between air and coolant while there is counter flow between front and back row of coolant flow. This multi direction and multi pass flow arrangement enables us to achieve high temperature difference between inlet and outlet of heat exchanging fluids unlike conventional heater cores. Coolant flow in the heater core assembly is also shown in FIGS. 3a and 3b.

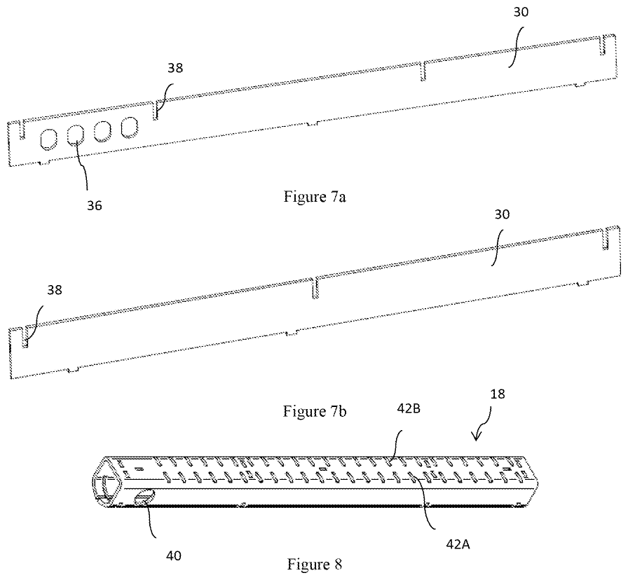

FIGS. 7a and 7b shows left and right-side partition plate (30). Left side partition plate (30) is showing a plurality of holes to enable transfer of the coolant from the first D-header chamber (18a) to the second D-header chamber (18b) or vice versa along the depth of the heater core (12). The left and right-side partition plate (30) have a plurality of slots (38) to accommodate end plate/baffle (20) therein.

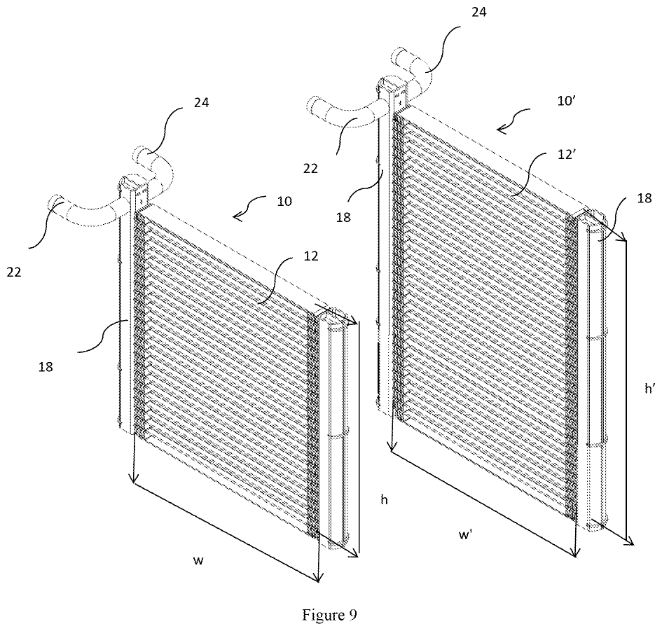

FIG. 8 indicates left side of the D-header (18) having a hole (40) for the inlet (22) and the outlet pipes respectively. Moreover, D-header (18) comprises plurality of holes (40) are arranged on the flat surface of D-header (18) wherein the plurality of slots (42A, 42B) is disposed in a first row and second row in the longitudinal direction of the D-header (18) to accommodate the micro-channels (14). FIG. 9 shows a heater core assembly (10, 10′) having flexible core (12, 12′) options with superior performance in comparison to conventional heater cores. Different core sizes can be easily manufactured just by increasing the width (w, w′) and height (h, h′) of the micro-tubes stacked in horizontal rows (15) of the core (12), without investing in new tooling.

The CCF heater core assembly (10) can be used in a variety of applications and is not restricted to electric vehicles only. The present subject matter provides a user to manufacture CCF heater core assembly (10) of various core sizes as per space constrain with superior performances specification and reduced weight solution for IC engines also.

In an embodiment, the CCF heater core is using battery heat, to provide heat to the cabin, correspondingly increasing battery life by cooling battery coolant and also reducing battery power consumption. While in present electric vehicles HVAC circuit, an electric heater/PTC heater is used, this consumes battery power rapidly. So, present invention instead of consuming battery power will provide heat recovery to the system. This will improve electric vehicle mileage/charge in winter conditions.

In an embodiment, the CCF heater core assembly provides minimum 10 to 15% improved heat rejection, with comparatively less restriction on Air side and better uniformity on coolant side. It also eliminates plentiful brazing joints (34) present in conventional oval tube design (36) facilitating leak proof heater core assembly.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore, contemplated that such modifications can be made without departing from the spirit or scope of the present invention as defined.

We claim:

1. A heater core assembly (10) comprising:
a core (12) comprising a plurality of micro-tubes (13A, 13B), the plurality of micro-tubes (13A, 13B) being stacked in horizontal rows (15) between at least two headers (18) by inserting ends of each of the micro-tubes (13A,13B) into slots (42A, 42B) provided in the headers (18);
a partition plate (30) disposed vertically in each of header (18) to define two vertical chambers (18A, 18B);
wherein each of the horizontal rows (15) include at least one first micro-tube (13A) inserted in the first chamber (18A) and at least second micro-tube (13B) inserted in the second chamber (18B) to enable flow of the coolant in the core assembly (10).

2. The heater core assembly (10) as claimed in claim 1, wherein the flow of the coolant in the first micro-tube (13A) is in opposite direction to the flow of the coolant in the second micro-tube (13B) resulting in counter flow effect of the coolant.

3. The heater core assembly (10) as claimed in claims 1 to 2, wherein the coolant flows into the micro-channels (14) and air flows through fins (16) to enable cross flow between hot coolant and air.

4. The heater core assembly (10) as claimed in claims 1 to 3 wherein a coolant inlet (22) is connected to the first chamber (18A) and a coolant outlet (24) is connected to the second chamber (18B) of the header (18).

5. The heater core assembly (10) as claimed in claim 1, wherein each of the micro-tubes (13A, 13B) comprises a plurality of micro-channels (14).

6. The heater core assembly (10) as claimed in claims 1 to 4, wherein the partition plate (30) comprising a plurality of holes enabling transfer of the flow of the coolant from the first micro-tube (13A) to the second micro-tube (13B) or vice versa along the depth of the heater core (12).

7. The heater core assembly (10) as claimed in claims 1 to 5, wherein a plurality of baffles (20) is inserted in a plurality of slots formed on the partition plate (30), said baffles (20) are configured to close both ends of each of the header (18) and to increase the number of passes of the coolant in the each of the header (18).

8. The heater core assembly (10) as claimed in claim 1, wherein the core (12) comprises a plurality of fins (16) disposed between each row (15) of the horizontal micro-channels (14).

9. The heater core assembly (10) as claimed in claim 1, wherein at least one plate (26) being disposed at the top and at the bottom of horizontally stacked rows (15) of the micro-tubes (13A, 13B) to support the plurality of last fins (16) and to provide stiffness to the core (12).

10. The heater core assembly (10) as claimed in claim 1, wherein the heater core assembly (10) comprises the core (12) having a variable high (h, h′) and variable width (w, w′) of micro-tubes stacked in horizontal rows (15).
